(19) United States
(12) Patent Application Publication
(10) Pub. No.: US 2008/0166133 A1
(43) Pub. Date: Jul. 10, 2008

(54) OPTICAL NETWORK REMOTE POWER SUPPLY SYSTEM FOR REMOTE SWITCHING UNIT

(75) Inventor: Ching-Wen Hsiao, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC MULTIMEDIA & TELECOM CORPORATION, Taipei (TW)

(21) Appl. No.: 11/621,069

(22) Filed: Jan. 8, 2007

(51) Int. Cl. H04B 10/00

(52) U.S. Cl. 398/168; 398/171

(57) ABSTRACT

An optical network remote power supply system is proposed, which is designed for use with an optical network for supplying power to a remote switching unit, and which is characterized by the provision of a light source on the local site which can transmit a light beam via the optical transmission line to the remote site, where the light beam is converted into electricity for storage in an electrical energy storage module, such as a rechargeable battery unit or a capacitor. This feature allows the remote switching unit to be powered by the electricity stored in the electrical energy storage module in the event of a failure to the primary channel when the remote switching unit is responsible for switching to the secondary channel.

### BACKGROUND OF THE INVENTION

1. Field of the Invention

This invention relates to optical networking technologies, and more particularly, to an optical network remote power supply system which is designed for use with an optical network having a remote switching unit, for supplying power to the remote switching unit from a local site.

2. Description of Related Art

Optical networking is a communication technology for data transmission between computers, telephones and other electronic devices using laser beams transmitted through optical fibers. Optical networks can be used to transmit signals either in analog or digital forms. Since laser beams are much higher in frequency than electrical and radio signals, optical networking is far more reliable and has far greater transmission capacity than traditional cable and radio communications.

Passive optical network (PON) systems are a widely employed technology for data communication between the Internet and local area networks that are used for connection to private users and small business entities. In practice, a PON system typically utilizes just one single strand of optical fiber for two-way transmission of optical signals to and from the client sites.

One drawback to the traditional single-fiber two-way PON systems, however, is that when the single fiber is damaged or fractured, the data communication to the client sites is entirely disconnected. One solution to this problem is to provide two channels (i.e., two strands of fibers) in the optical transmission path: a primary channel and a secondary channel, where the primary channel is initially set to active mode while the secondary channel is set to standby (backup) mode, such that in the event of a failure to the primary channel (such as when fractured), the optical transmission path can be promptly switched to the secondary channel. To achieve this purpose, a present solution is to provide a local switching unit and a remote switching unit on both sides of the optical network, such that in the event of a failure to the primary channel, both of these two switching units can be activated to perform the required switching actions.

In practice, however, since a PON system has a passive optical data processing unit on the remote site (i.e., the remote optical data processing unit has no internal power supply), there exists a need for an optical network remote power supply system that can supply power to the remote switching unit.

### SUMMARY OF THE INVENTION

It is therefore an objective of this invention to provide a optical network remote power supply system which is capable of supplying electrical power to a remote switching unit in an optical network system.

The optical network remote power supply system according to the invention is designed for use with an optical network system, particularly a PON (Passive Optical Network) system, for supplying power to a remote switching unit from the local site.

In assembly, the optical network remote power supply system according to the invention is based on a distributed architecture comprising: (A) a local power source unit; and (B) a remote power storage unit; wherein the local power supply unit is integrated to the local switching unit and includes: (A1) a light-emitting module, which is capable of emitting a light beam; and (A2) a light-beam multiplexing module, which is coupled to a light output port of the local optical data processing unit for injecting the light beam emitted from the light-emitting module in a multiplexed manner into the optical transmission line for transmission through the optical transmission line to the remote switching unit; and wherein the remote power storage unit is integrated to the remote switching unit and includes: (B1) a light division module, which is capable of dividing the light beam that is transmitted by the local power source unit through the optical transmission line from the remote optical data processing unit; (B2) a light-to-electricity transducer module, which is capable of converting the energy of the light beam received by the light division module into electrical energy; and (B3) an electrical energy storage module, which is used to store the electrical energy produced by the light-to-electricity transducer module and utilize the stored electrical energy as a power source for the remote switching unit.

The optical network remote power supply system according to the invention is characterized by the provision of a light source on the local site which can transmit a light beam via the optical transmission line to the remote site, where the light beam is converted into electricity for storage in an electrical energy storage module, such as a rechargeable battery unit or a capacitor. This feature allows the remote switching unit to be powered by the electricity stored in the electrical energy storage module in the event of a failure to the primary channel when the remote switching unit is responsible for switching to the secondary channel.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the optical network remote power supply system of the invention;

FIG. 2 is a schematic diagram showing the internal architecture of the local power source unit utilized by the optical network remote power supply system of the invention;

FIG. 3 is a schematic diagram showing a first preferred embodiment of the internal architecture of the remote power storage unit utilized by the optical network remote power supply system of the invention;

FIG. 4 is a schematic diagram showing a second preferred embodiment of the internal architecture of the remote power storage unit utilized by the optical network remote power supply system of the invention; and

FIG. 5 is a schematic diagram showing a third preferred embodiment of the internal architecture of the remote power storage unit utilized by the optical network remote power supply system of the invention.

### DETAILED DESCRIPTION OF PREFERRED EMBODIMENTS

The optical network remote power supply system according to the invention is disclosed in full details by way of preferred embodiments in the following with reference to the accompanying drawings.

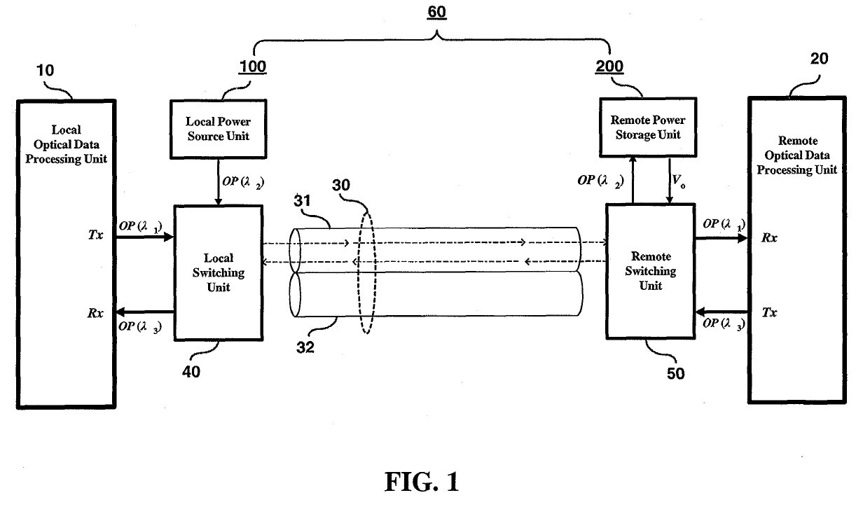

FIG. 1 is a schematic diagram of an optical network and a optical network remote power supply system 60 applied to the optical network according to the present invention. The optical network remote power supply system 60 comprises a local power source unit 100 and a remote power storage unit 200 separated from the local power source unit 100, for integration to the optical network, for example a passive optical network (PON), which comprises a local optical data processing unit 10, a remote optical data processing unit 20, an optical transmission line 30, a local switching unit 40, and a remote switching unit 50. The optical transmission line 30 is interconnected between the local optical data processing unit 10 and the remote optical data processing unit 20 and includes a primary channel 31 and a secondary channel 32. In practical implementation, the optical transmission line 30 can be realized by using two optical fibers stranded together into a single line, one of which servers as the primary channel 31 and the other serves as the secondary channel 32. Initially, the optical network system is set to operate on the primary channel 31, i.e., the primary channel 31 is used for transmission of optical signals between the local optical data processing unit 10 and the remote optical data processing unit 20; and in the event of a failure to the primary channel 31, both the local switching unit 40 and the remote switching unit 50 are activated to switch the optical transmission path from the failed primary channel 31 to the secondary channel 32. In PON application, for example, the local optical data processing unit 10 is an optical line terminal (OLT), while the remote optical data processing unit 20 is an optical splitter unit; and the local switching unit 40 includes a pair of optical switches 41, 42, while the remote switching unit 50 also includes a pair of optical switches 51, 52.

In actual operation, the local optical data processing unit 10 and the remote optical data processing unit 20 can communicate with each other via the optical transmission line 30 by means of laser beams. The local optical data processing unit 10 includes a light transmitting port (Tx) 11 and a light reception port (Rx) 12; and similarly, the remote optical data processing unit 20 also includes a light transmitting port (Tx) 21 and a light reception port (Rx) 22. The local optical data processing unit 10 is capable of emitting a signal beam OP(λ₁) having a wavelength of λ₁; and the remote optical data processing unit 20 is capable of emitting a signal beam OP(λ₃) having a wavelength of λ₃. Initially, the local switching unit 40 and the remote switching unit 50 are set to connect the primary channel 31 of the optical transmission line 30 between the local optical data processing unit 10 and the remote optical data processing unit 20, such that the local optical data processing unit 10 and the remote optical data processing unit 20 can transmit the signal beams OP(λ₁) and OP(λ₃) via the primary channel 31; and in the event of a failure to the primary channel 31, both the local switching unit 40 and the remote switching unit 50 will be activated to switch the connection to the secondary channel 32, such that the local optical data processing unit 10 and the local optical data processing unit 10 can nevertheless utilize the secondary channel 32 for transmitting the signal beams OP(λ₁) and OP(λ₃).

In the above-mentioned switching action, the electrical power needed by the local switching unit 40 can be directly supplied by the local optical data processing unit 10; but in a PON system, since the remote switching unit 50 has no power supply, the needed electrical power is supplied by the optical network remote power supply system of the invention 60.

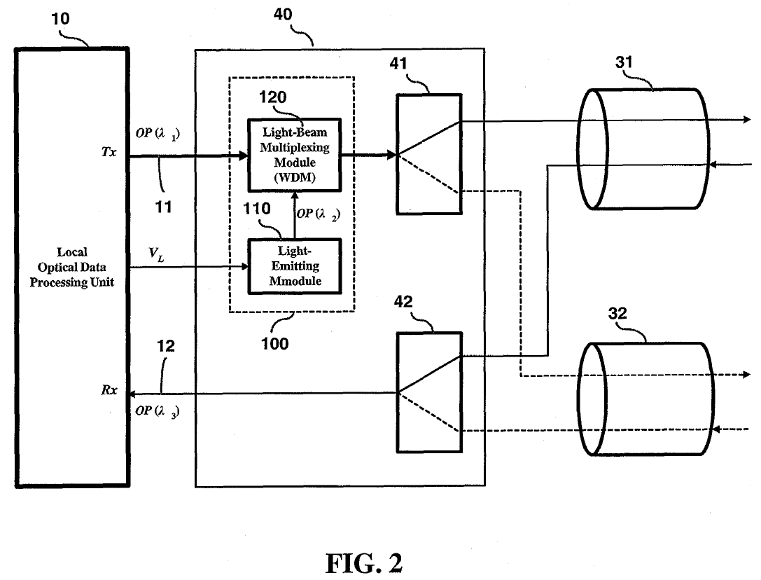

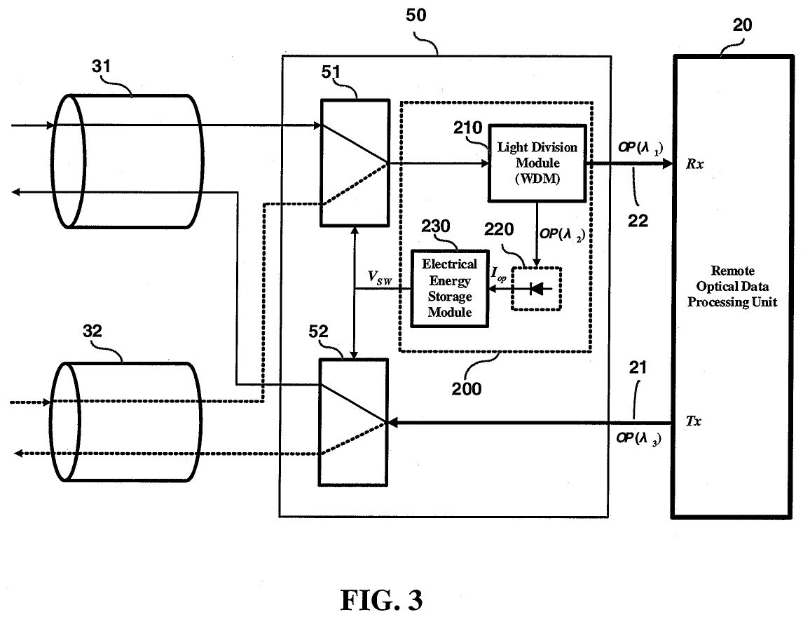

As shown in FIG. 1, the optical network remote power supply system of the invention 60 is based on a distributed architecture comprising 2 separate units: (A) a local power source unit 100 for integration to the local switching unit 40; and (B) a remote power storage unit 200 for integration to the remote switching unit 50; and wherein as shown in FIG. 2, the local power source unit 100 includes: (A1) a light-emitting module 110; and (A2) a light-beam multiplexing module 120; and as shown in FIG. 3, the remote power storage unit 200 includes: (B1) a light division module 210; (B2) a light-to-electricity transducer module 220; and (B3) an electrical energy storage module 230. Firstly, the respective attributes and behaviors of these constituent components of the invention are described in details in the following

The light-emitting module 110 is capable of emitting a light beam, such as a laser diode capable of emitting a laser beam OP(λ₂), where λ₂≠λ₁≠λ₃, and which is driven by an electrical voltage V_{L} supplied by the local optical data processing unit 10.

The light-beam multiplexing module 120 is for example a WDM (Wavelength Division Multiplexer) device, which is coupled to the light transmitting port (Tx) 11 of the local optical data processing unit 10 for injecting the light beam OP(λ₂) emitted from the light-emitting module 110 in a multiplexed manner into the optical transmission line 30 for transmission together with the signal beam OP(λ₁) through the optical transmission line 30 to the remote switching unit 50.

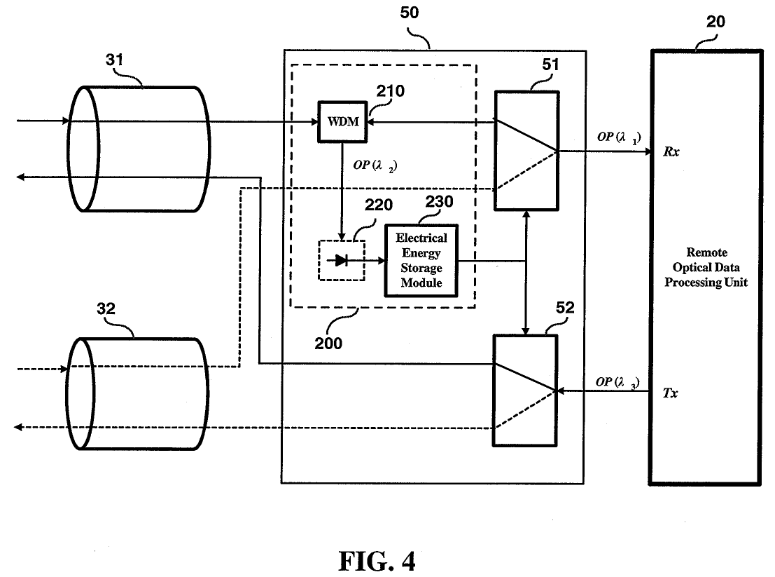

The light division module 210 can also be implemented with a WDM device, and which can be coupled to the optical network in several different manners. For example, as illustrated in FIG. 3, the light division module 210 can be coupled to the light reception port (Rx) 22 of the remote optical data processing unit 20; or as illustrated in FIG. 4, it can be alternatively coupled to the primary channel 31 of the optical transmission line 30. Either of these two embodiments allows the light division module 210 to divide the laser beam OP(λ₂) transmitted by the local power source unit 100 through the optical transmission line 30.

The light-to-electricity transducer module 220 is capable of converting the energy of the light beam OP(λ₂) received by the light division module 210 into electrical energy. In practical implementation, for example, the light-to-electricity transducer module 220 can be a light-sensitive diode or a solar cell, which can output an electrical current Iₒₚ in response to the OP(λ₂).

The electrical energy storage module 230 is capable of being charged by the electrical current Iₒₚ produced by the light-to-electricity transducer module 220 and thereby storing the electrical energy from Iₒₚ as a power source for the remote switching unit 50 when the remote switching unit 50 needs to perform a switching action. In practical implementation, for example, the electrical energy storage module 230 can be either a rechargeable battery unit or a capacitor. After being charged to full capacity, the electrical energy storage module 230 is capable of providing an electrical voltage VSW to drive both the optical switches 51, 52 in the remote switching unit 50 to perform a switching action when activated.

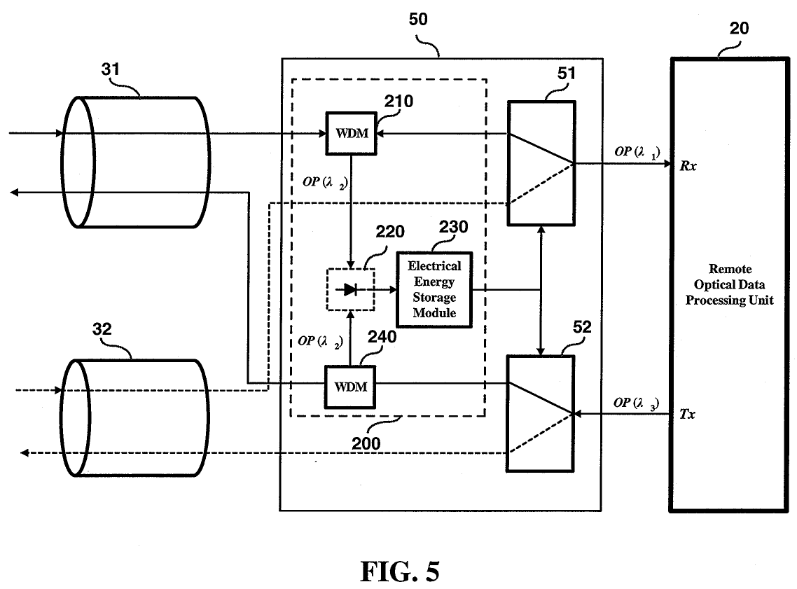

In addition to the embodiments shown in FIG. 3 and FIG. 4, the remote power storage unit 200 can further optionally include a secondary-channel light-division module 240 as illustrated in FIG. 5. As shown, the secondary-channel light-division module 240 is coupled to the secondary channel 32 of the optical transmission line 30, such that in the event after the light transmission path has been switched from the primary channel 31 to the secondary channel 32, it can divide the light beam OP(λ₂) transmitted from the local power source unit 100 through the secondary channel 32 for conversion by the light-to-electricity transducer module 220 into electrical energy.

The following is a detailed description of a practical application example of the optical network remote power supply system of the invention 60 during actual operation, which is described with reference to FIGS. 2 and 3.

As shown in FIGS. 2 and 3, during actual operation of the optical network, the local switching unit 40 and the remote switching unit 50 are initially set to interconnect the primary channel 31 of the optical transmission line 30 between the local optical data processing unit 10 and the remote optical data processing unit 20, such that the local optical data processing unit 10 and the remote optical data processing unit 20 can communicate with each other on light signals OP(λ₁) and OP(λ₃) transmitted and received via the primary channel 31. At the same time, the light-emitting module 110 in the local power source unit 100 is activated to emit a laser beam OP(λ₂), where λ₂≠λ₁≠λ₃; and the laser beam OP(λ₂) is then injected by the light-beam multiplexing module (WDM) 120 into the light transmitting port (Tx) 11 of the local optical data processing unit 10, such that the laser beam OP(λ₂) can be transmitted in a multiplexed manner with the signal beam OP(λ₁) through the optical transmission line 30 to the remote switching unit 50.

At the remote switching unit 50, the laser beam OP(λ₂) is intercepted by the light division module (WDM) 210 and then transferred to the light-to-electricity transducer module 220, where the laser beam OP(λ₂) is converted into electricity in the form of an electrical current Iₒₚ. The electrical energy of Iₒₚ is then stored into the electrical energy storage module 230 (which can be either a rechargeable battery or a capacitor).

Thereafter, in the event of a failure to the primary channel 31 of the optical transmission line 30 when it is necessary to switch to the secondary channel 32, the local switching unit 40 and the remote switching unit 50 will be activated to cooperatively perform the required switching action. Under this condition, the local switching unit 40 can be powered by the local optical data processing unit 10 to perform the switching action, whereas the remote switching unit 50 can be powered by the output voltage V_{SW} of the electrical energy storage module 230.

In the case of the embodiment of FIG. 5, after the optical transmission path has been switched from the primary channel 31 to the secondary channel 32, the remote power storage unit 200 can still rely on the secondary-channel light-division module 240 for dividing the laser beam OP(λ₂), such that the electrical energy storage module 230 can still be charged by the energy from the laser beam OP(λ₂). When it is necessary to switch the optical transmission path back to the primary channel 31, the remote switching unit 50 can be powered by the output voltage V_{SW} of the electrical energy storage module 230 to perform this switch-back action.

In conclusion, the invention provides an optical network remote power supply system which is designed for use with an optical network for supplying power to a remote switching unit, and which is characterized by the provision of a light source on the local site which can transmit a light beam via the optical transmission line to the remote site, where the light beam is converted into electricity for storage in an electrical energy storage module, such as a rechargeable battery unit or a capacitor. This feature allows the remote switching unit to be powered by the electricity stored in the electrical energy storage module in the event of a failure to the primary channel when the remote switching unit is responsible for switching to the secondary channel. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An optical network remote power supply system for use with an optical network having a local optical data processing unit, a remote optical data processing unit, a local switching unit, a remote switching unit, and an optical transmission line connected between the local optical data processing unit and the remote optical data processing unit and including a primary channel and a secondary channel, the optical network remote power supply system comprising:
a local power source unit integrated to the local switching unit, the local power supply unit having a light-emitting module for emitting a light beam, and a light-beam multiplexing module coupled to a light output port of the local optical data processing unit for injecting the light beam emitted from the light-emitting module in a multiplexed manner into the optical transmission line and to the remote switching unit; and
a remote power storage unit integrated to the remote switching unit, the remote power storage unit having a light division module for dividing the light beam transmitted from the local power source unit through the optical transmission line, a light-to-electricity transducer module for converting the light beam received by the light division module into electrical energy, and an electrical energy storage module for storing the electrical energy produced by the light-to-electricity transducer module and for driving the remote switching unit with the stored electrical energy.

2. The optical network remote power supply system of claim 1, wherein the optical network is a passive optical network (PON).

3. The optical network remote power supply system of claim 1, wherein the local optical data processing unit is an optical line terminal (OLT), and the remote optical data processing unit is an optical splitter unit.

4. The optical network remote power supply system of claim 1, wherein the light-emitting module is a laser diode.

5. The optical network remote power supply system of claim 1, wherein the light-beam multiplexing module is a wavelength division multiplexer (WDM).

6. The optical network remote power supply system of claim 1, wherein the light division module is a wavelength division multiplexer (WDM).

7. The optical network remote power supply system of claim 1, wherein the light division module is coupled to a light-reception port of the remote optical data processing unit.

8. The optical network remote power supply system of claim 1, wherein the light division module is coupled to the primary channel of the optical transmission line.

9. The optical network remote power supply system of claim 1, wherein the light-to-electricity transducer module is a light-sensitive diode.

10. The optical network remote power supply system of claim 1, wherein the light-to-electricity transducer module is a solar cell.

11. The optical network remote power supply system of claim 1, wherein the electrical energy storage module is a rechargeable battery unit.

12. The optical network remote power supply system of claim 1, wherein the electrical energy storage module is a capacitor.

13. The optical network remote power supply system of claim 1, wherein the remote power storage unit further comprises:
a secondary-channel light-division module, which is coupled to the secondary channel of the optical transmission line, for use in an event that the light transmission path has been switched from the primary channel to the secondary channel to intercept the light beam transmitted from the local power source unit through the secondary channel for conversion by the light-to-electricity transducer module into electrical energy for use by the remote switching unit to perform a recovering switching action.
